(19) United States
(12) Patent Application Publication
(10) Pub. No.: US 2012/0312828 A1
(43) Pub. Date: Dec. 13, 2012

(54) Trash Container Venting Device

(76) Inventor: George W. Herndon, Thomasville, GA (US)

(21) Appl. No.: 13/316,630

(22) Filed: Dec. 12, 2011

Related U.S. Application Data
(60) Provisional application No. 61/441,735, filed on Feb. 11, 2011.

(51) Int. Cl. B65F 1/14

(52) U.S. Cl. 220/720; 220/745

(57) ABSTRACT

A vent device has an elongate body having a main body of one or two members with a top end and a bottom end, an elongate side member on each side of the main body being bent inward the same direction, and a suspension clip formed on an end of each elongate side member for suspending the vent device from the rim of a trash container. When formed of two members comprising an upper member and lower member, the lower body member includes preformed clips for attachment through slots on the upper body member and the length of the device is determined by the slots selected for insertion of the clips. The main body may include score lines for breaking off portions of the main body and adjusting the length of the device to fit the height of a trash container.

### PRIORITY CLAIM

The present application claims benefit of U.S. Provisional Patent Application No. 61441735 filed on Feb. 11, 2011.

### FIELD OF THE INVENTION

The present invention relates to a method and device for relieving air vacuum within a trash container to assist in the removal of plastic liners and, in particular, to an adjustable length vent device for insertion and bearing against a trash container's interior sidewall surface to form a passage for air.

### BACKGROUND OF THE INVENTION

It is a well-known problem that trash bags may create a vacuum between the bag and a trash container's inside sidewall after insertion, especially after a large amount of garbage has been deposited into the container. Trash bags are inserted through an open top of trash containers and removed by pulling back through that same open top. A vacuum forms as air is forced out of the space between the bag and the container wall when a bag is inserted through the open top of the container. The trash bag lines the interior surface of the container's inside sidewall becomes flush against the interior surface including the bottom wall of the compartment formed by the trash container. These trash containers are formed with smooth interior sidewalls and bottom wall for easy removal of trash bag liners, but these same smooth surfaces tend to promote formation of a vacuum. Thus, when the trash container is full and the bag needs to be removed, the bag has sealed itself against the interior surface. As the bag pulls upward, a vacuum forms below the bag, as there is not a source of air for filling the area beneath the bag because of the seal between bag and wall. This makes removal of trash bags from containers very difficult at times, especially with the removal of large heavy bags from larger containers.

A need exists to alleviate formation of a vacuum when bags are removed from trash containers. Some trash containers are now constructed with structural features or airways to prevent formation of a vacuum. These features include various holes and breathing devices in the bottom of a trash container that can leak and cause a mess or flapper valves incorporated into the side of the trash container that require physical modification of the container. In another attempt to alleviate vacuum, a plastic tube is run down the inside of a trash container to below a trash bag, which provides a limited airflow for releasing vacuum. However, this does not address the need for ample vacuum release and to solve the vacuum problem in existing trash containers that do not have vacuum release features or new containers that do not incorporate such features. Thus, another need exists to alleviate formation of a vacuum with respect to preexisting trash containers and those that are presently manufactured without vacuum relieving features.

U.S. Pat. No. 6,015,063 to Poliquin teaches a trash can vent system that can be secured to a trash container without an integrated vacuum release. In particular, Poliquin provides a vent channel positioned along the interior sidewall of the trash container having a number of vent openings formed through the channel member. The Poliquin device includes an edge securing cap with a right-angled corner lip with edge receiving slots for securing the vent channel member above the corner edge of a trash container opening.

The vent device taught by Poliquin is useful, but limited to square or rectangular shaped trash containers. However, it would be advantageous to have a vent system that is flexible and includes attachment to different shape trash containers, including round and oval. It would also be advantageous to have a universal vent system that is adjustable and will work with trash containers of various lengths.

### SUMMARY OF THE INVENTION

An open-ended snorkel-like trash receptacle venting device is provided as a one-piece or two-piece accessory for trash receptacles to assist in the removal of a filled disposable plastic trash bag from a trash container. When the trash bag is filled and thereafter lifted out of the trash container, the snorkel-like trash receptacle venting device permits an unconstrained downward inflow of air to stop the formation of a constraining vacuum under the filled trash bag.

The venting device has a molded or extruded elongate plastic body member in one embodiment with an integral pair of hook shaped tabs forming suspension hangers for hanging of the vent device on the lip of a trash container. In another embodiment of the venting device the elongate body member includes two separable sections, an upper member and a lower member. Both of these members of a two-piece device may also be comprised of molded or extruded plastic. These two separable members overlap and slide and adjust with respect to the other so as to change the overall length of the vent device.

In each embodiment, the elongate body includes a main body member bordered by side members that are bent downward along the body's elongate length forming sides of an elongate channel. The side members extend toward the inner sidewall of the trash container when inserted therein. The side members abut against the inner sidewall of the interior surface of a trash container, whereby the elongate channel defined by the main body member and the side members forms a vent chamber passage in combination with the trash container for passage of air between the container's interior sidewall surface and the inside of the vent device's elongate body. Openings are formed on each end of the elongate body at both the top and bottom ends providing a cross-sectional thru-put capacity for airflow through the passage.

Therefore, a principle object of the present invention is to prevent vacuum restraint during removal of a plastic trash bag liner from a trash container and to reduce the labor involved in bag removal without requiring acquisition of a new vented container.

Another object of the invention is to provide an after-market trash container vent device that can be secured to nearly any existing or non-vented trash container including kitchen trash cans, outdoor cans, barrel trash cans, parks and recreational area trash cans, and restaurant trash cans.

Still another object is to provide a vent device for attachment to a trash container that is flexible and attaches to trash containers that are any shape including round, oval or square, thus reducing the need for new and replacement trash receptacles and thereby providing an environmentally friendly way to help conserve resources used to manufacture new trash receptacles.

Another object is to provide a vent device for attachment to a trash container that has adjustable length and attaches to trash containers that are any length.

Another object is to provide a vent device that is inexpensive and simple to construct of either one or two parts of material and has no other moving parts.

Yet another object is to provide a vent device that allows air to be drawn in below a bag liner into a container and prevent vacuum.

Another object is to provide a vent device that relieves air build up during insertion of a bag lining.

Another object is to provide a vent device that is simple, easy to use, requires no tools for installation and does not interfere with operation of a trash container.

Another object is to provide a vent device with low resistance to removal that will not inhibit removal of a bag lining from the container because of hanging or friction.

Another object is to provide a vent device that is portable and can be used with any choice of trash containers and readily moved from one to another.

Yet another object is to provide a vent device that does not require cutting or modification to existing trash containers to be used effectively and does not create a hole for entry of rodents into the trash container.

These and other objects are accomplished by the present invention disclosed in the drawings and the detailed description of an exemplary embodiment provided below.

### BRIEF DESCRIPTION OF THE DRAWINGS

FIG. 1 is a front side perspective view of a vent device in accordance with a preferred embodiment of the invention.

FIG. 2 is a rear side perspective view of a vent device.

FIG. 3 is a front side perspective view of a vent device attached in combination with a typical trash container.

FIG. 4 is a side cross-sectional view along line 4-4 of FIG. 3 of a vent device attached to a side wall of a trash container.

FIG. 5 is an enlarged cross-sectional side perspective cut-away view of the clip portion of the vent device.

FIG. 6A is an enlarged cross-sectional side cut-away view of the clip portion of the vent device indicated by line 6-6 of FIG. 4.

FIG. 6B is an enlarged cross-sectional side cut-away view of the clip portion of the vent device indicated by line 6-6 of FIG. 4 illustrating operation of the clip.

FIG. 7 is an enlarged cross-sectional side cut-away view of the suspension portion of the vent device in combination with a trash container.

FIG. 8A is a cross-sectional side view of the vent device in combination with a trash container and a disposable plastic trash bag.

FIG. 8B is a cross-sectional side view cut-away of a vent device in combination with a trash container and a disposable plastic bag, further illustrating a scent dispensing element contained with the cavity between the vent device and the trash container sidewall.

FIG. 9A is a rear side view of a plastic blank used for construction of a vent device in accordance with an embodiment of the invention.

FIG. 9B is a rear side perspective view of the plastic blank with dashed lines showing where the plastic blank is modified to create hanging members.

FIG. 9C is a rear side perspective view of a single-piece vent device in accordance with the present invention formed from the blank in FIGS. 9A and 9B.

FIG. 10 is a front side perspective view of the single-piece vent device in FIG. 9C.

### DETAILED DESCRIPTION

Referring now to the figures, a particular embodiment of the invention is shown that provides a method to avoid the formation of a vacuum within a trash container 2. The vent device 3 shown prevents constraint by vacuum during extraction of a plastic trash bag liner 5, especially after the bag has been filled, whereby the bag presses against the inner sidewall 7 of the container.

The vent device 3 used in the method is constructed of any suitable flexible material for the functions of the invention. The most likely preferred material in most applications will be plastic such as vinyl, polyethylene, extruded plastics and the like. However, it is envisioned that industrial versions, decorative versions, or disposable versions might be constructed primarily of metal, paper (cardboard), rubber, glass, ceramic, wood, fiberglass, or other synthetic material. In particular, some household might prefer a decorative version of the vent device 3 that features artistic features or the like. Alternatively, the vent device 3 might be combined with logos or words for marketing of products or businesses and might be constructed of cardboard or other disposable material for use as a promotional item that can be produced at very low cost and given away. Plastic is expected to work well for the body of the vent device 3 because it is a flexible material and will promote use of the vent device 3 on existing trash containers, and plastic can be extruded or molded for mass manufacture at low cost. Moreover, plastic will generally be a long-lasting material that can hold up for the life of a trash container.

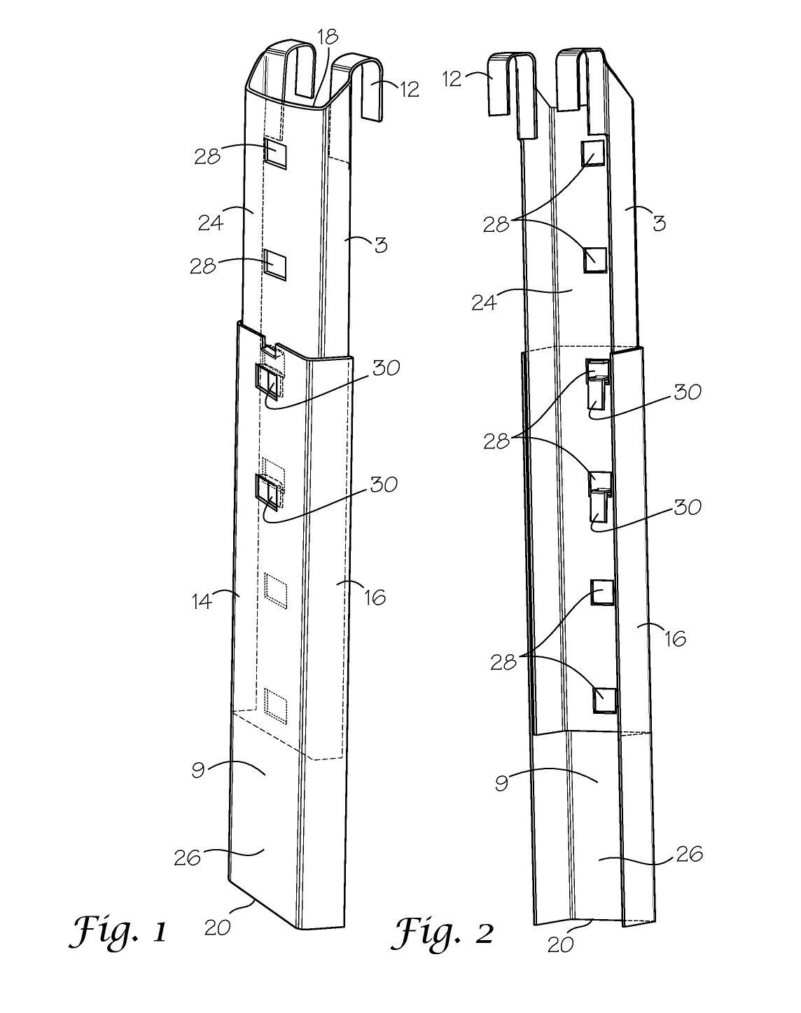

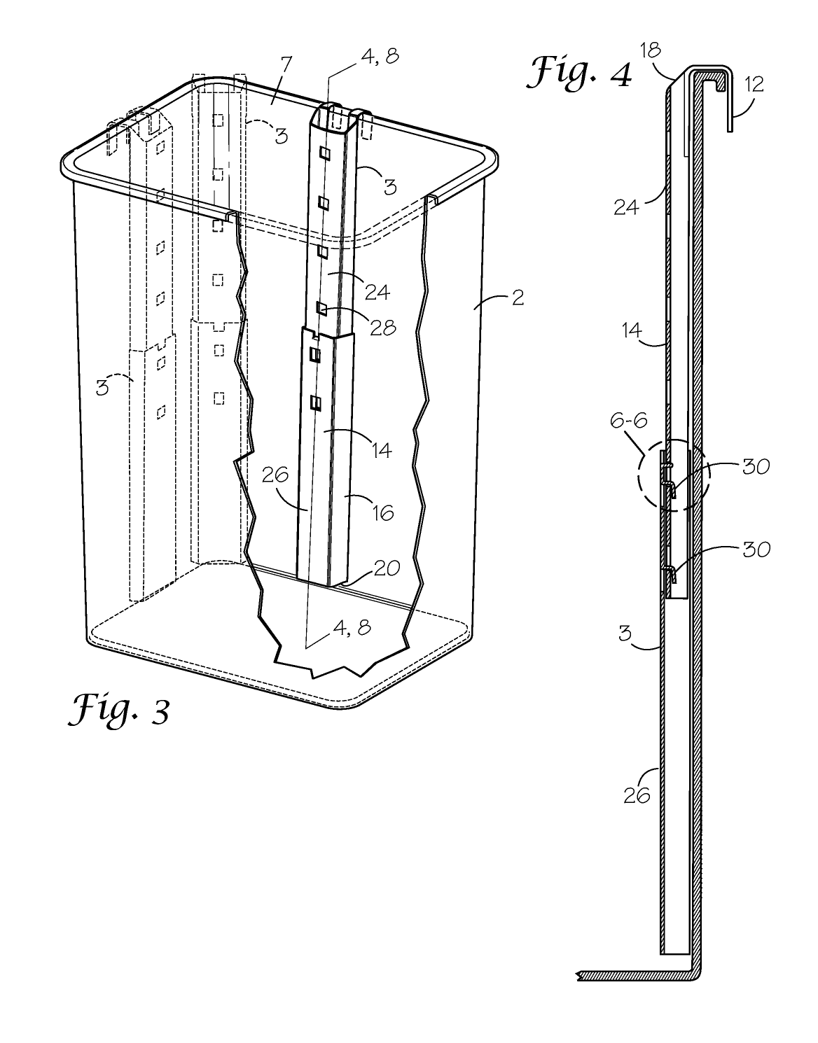

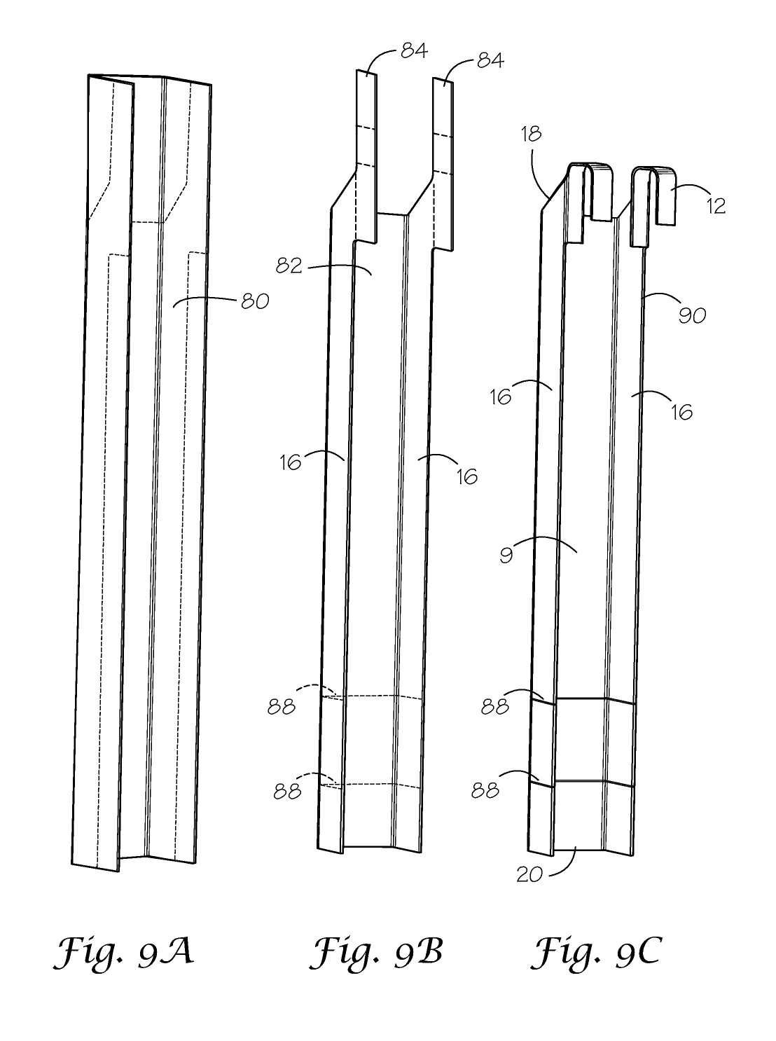

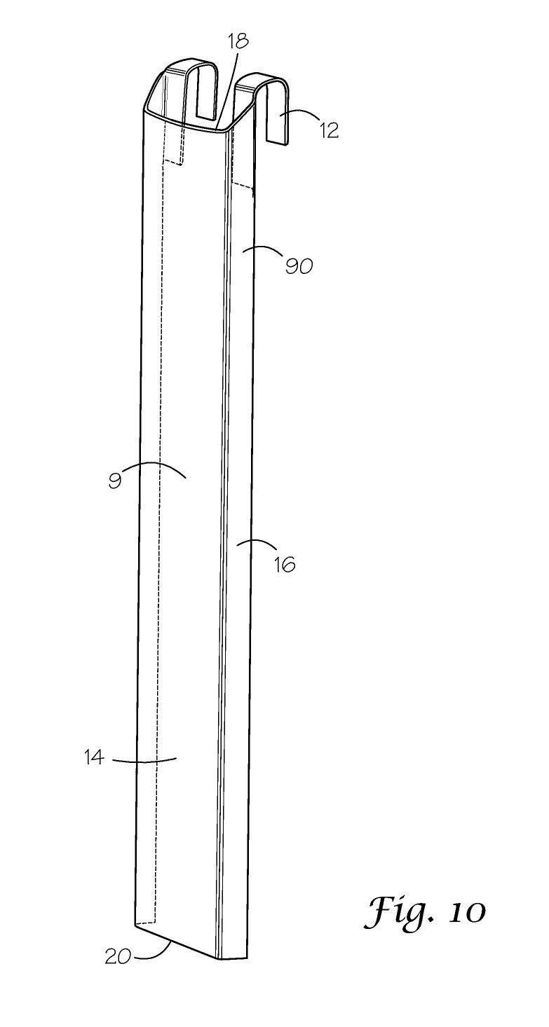

FIG. 1 shows an embodiment of a vent device 3 that is comprised of two sections for adjustable length. FIG. 2 shows the reverse side of the vent device. The vent device 3 is designed for insertion into a trash container 2 as shown in FIG. 3. In one particular embodiment of the invention, the vent device 3 is formed from a plastic blank 80 as shown in FIG. 9A-9C. The entire body of the device in the embodiment shown is extruded or stamped and formed from a single piece of plastic. A section of the plastic form as shown in FIG. 9A forms the blank that is stamped or formed to create the single piece vent device 90 as shown in FIG. 10. Alternatively, more than one blank is stamped to form a multiple-part adjustable length vent device 3, or a single piece blank is cut into multiple parts.

The plastic may be pre-formed into a c-shape as shown in FIG. 9A as a part of a molding or extrusion process to minimize manufacture time. The basic shape of the plastic blank 80 as shown in FIG. 9B is provided in the c-shape that defines the shape of an elongate channel that will help define a passage when used in combination with a trash container for airflow through the vent device 3. As shown in FIG. 9B, the extruded plastic is stamped into a pre-formed blank 82 with flange members 84 to be bent and formed into the hanging members 12 shown in FIG. 9C. As the plastic blank 80 is manufactured it will be cut to a desired length or situated for further processing. In particular with the single piece vent device 90 of FIGS. 9C and 10, the plastic blank 80 may be manufactured in several standard lengths for common height trash containers.

The determination of length of the vent device 90 may be accomplished by any suitable means, but it is especially contemplated that a plastic extrusion forming the plastic blank 80 may be scored with score lines 88 for separation as shown in FIGS. 9A-9C or that the device will be manufactured in two pieces forming a multi-part vent device 3 as shown in FIG. 1. As shown in FIG. 9B, each separate plastic blank 80 may be scored at certain intervals for easy breaking of a piece from the bottom end of the elongate plastic body 9 of the device to adjust length, which removes excess material beyond the length desired. Any such excess is discarded. With this embodiment in mind, the vent device 90 may also be manufactured and sold in sets of two or more that are scored between each device at intervals such that the device is broken to separate each device of the set.

In FIG. 9B, the pre-formed stamped blank 82 includes tabs 84 that have been cut out of the plastic form. These tabs 84 provide the members of the plastic blank 80 for forming a suspension portion of the device comprising hook shaped clips or suspension hangers 12. The tabs 84 are bent inward to form the suspension hangers 12 for hanging the device on rim of a trash container 2. In this embodiment, the plastic blank 82 promotes having a single piece construction that is simple and easy to manufacture. The plastic suspension hangers 12 formed from the tabs 84 provide a flexible hanging means that can be used to retain the vent device 90 on several varieties of trash containers. And, the simple single wall design provides flexibility for use of the vent device 90 with several shapes of containers.

The vent device 3, 90 includes an elongate plastic body having a centrally situated vertical main body member having an approximately flat or curved outer surface 14. When a trash bag liner 5 is inserted into the trash container 2 having the vent device 3, the outer surface 14 of the main body member of the vent device 3 will be the main portion that bears against the bag. The outer surface 14 is preferably smooth, whereby the bag will not snag or hang on the vent device 3. The vent device 3 does not provide any unnecessary friction or resistance to the removal of the bag liner.

The vent device 3 further includes a side member 16 appending from each edge of the main body member along the entire length thereof. These side members 16 bend angularly with respect to the main body member on each side of the main body. The combination of the side members and the main body member define the elongate channel created by the c-shaped cross-section of the elongate body of the device. The bends attached to the main body member create the elongate side members 16 on each side of the main body that extend toward inner sidewall 7 on the interior surface of trash container 2. Each elongate side member 16 bears against the interior surface of the container of the inner sidewall 7 when the vent device 3 is suspended or attached to the trash container 2. In the embodiment shown where the device is constructed of a single wall plastic member, the elongate side members 16 have some flexibility for adjusting to the inner shape of the trash container 2. Thus, the side members 16 will preferable abut against an interior surface of the trash container 2 defined by the inner sidewall 7 of the container. The elongate channel in combination with the interior surface of the trash container will define a passage comprising an elongate air transfer chamber for transfer and flow of air along the interior surface and sidewall between the trash container 2 and the vent device 3.

As shown in FIG. 1, the vent device 3 includes a flexible elongate body 9 and suspension hangers 12. As discussed, these features of the particular embodiment work with different types and sizes of trash containers because the suspension hangers are flexible enough to mold to the shape of the container, and the elongate side members 16 of the vent device 3 each provide an edge of the channel's body that conforms to rest against the inner sidewall 7 of trash container 2 as shown in FIG. 3.

After insertion into a trash container 2, the vent device 3 is open-ended on both the top end and bottom end. The channel formed between the vent device 3 and the container's sidewall 7 creates a vent for airflow along the inside surface of the trash container 2. The open top end is formed against inner sidewall 7 as shown in FIG. 3. This top end is formed by cutting of the plastic into the shape of the plastic blank 80 shown in FIG. 9B and discussed above, whereby a desirable one piece construction is provided. Variations of this shape will be apparent; however, having the vent device 3 with a top end edge 18 of the elongate body tapered at about 45 degrees promotes easy insertion and removal of bag liners from a container and does not interfere with the lid of the container. Further, the angle of the top end edge 18 prevents the bag and the trash container lid from blocking airflow and also even increases the size of the opening on the top end to further enhance airflow through the channel. The angle of the top end edge 18 is formed by the manner in which the side members are cut at the top of the plastic blank 80. The angle of the top end edge 18 is formed by cutting the side members 16 at an angle that runs from the edge of top of the body to about where the suspension hanger is formed by bending the tabbed portion of the plastic blank 80.

The opposing end of the vent device 3 opposite the top end provides an open bottom end that is formed by the device abutting against the inner sidewall 7 of the trash container 2 similar to the manner in which the open top end was formed. However, the vent device 3 bottom end may be cut in a manner in which the bottom edge 20 of the vent's elongate body on the bottom end of the device is perpendicular and squared with respect to the channel body. Optionally, the bottom edge 20 might be tapered or angled, but it is expected that the bottom edge 20 will be preferred to be squared to the channel body in most practice because this will prevent exposing the opening of the bottom end to the outer side surface of the bag liner 5. This positioning of the opening of the bottom end will prevent sealing of the opening of the bottom end by the bag liner.

Further, this positioning does not create a jutting extension on the bottom edge 20. For instance, if the angle were inward into the trash container sidewall 7, a jutting extension might be created that the bag liner could hang on during removal causing tearing of the bag liner 5. In this regard, an angle may be created on the bottom end by inclusion of some rounding or tapering off of the bottom edge 20 of the elongate body forming the bottom end. Such rounding or tapering may be integrated into a more robust design to reduce friction and hanging because of edge surfaces. Any sharp corners on the bottom end of the vent device 3 or anywhere on the elongate body of the device should be avoided to prevent tearing of bags or hanging of the bag during removal. The present vent device 3 is readily made in a way to avoid such problems while being simply constructed out of a single member of plastic as shown in the figures.

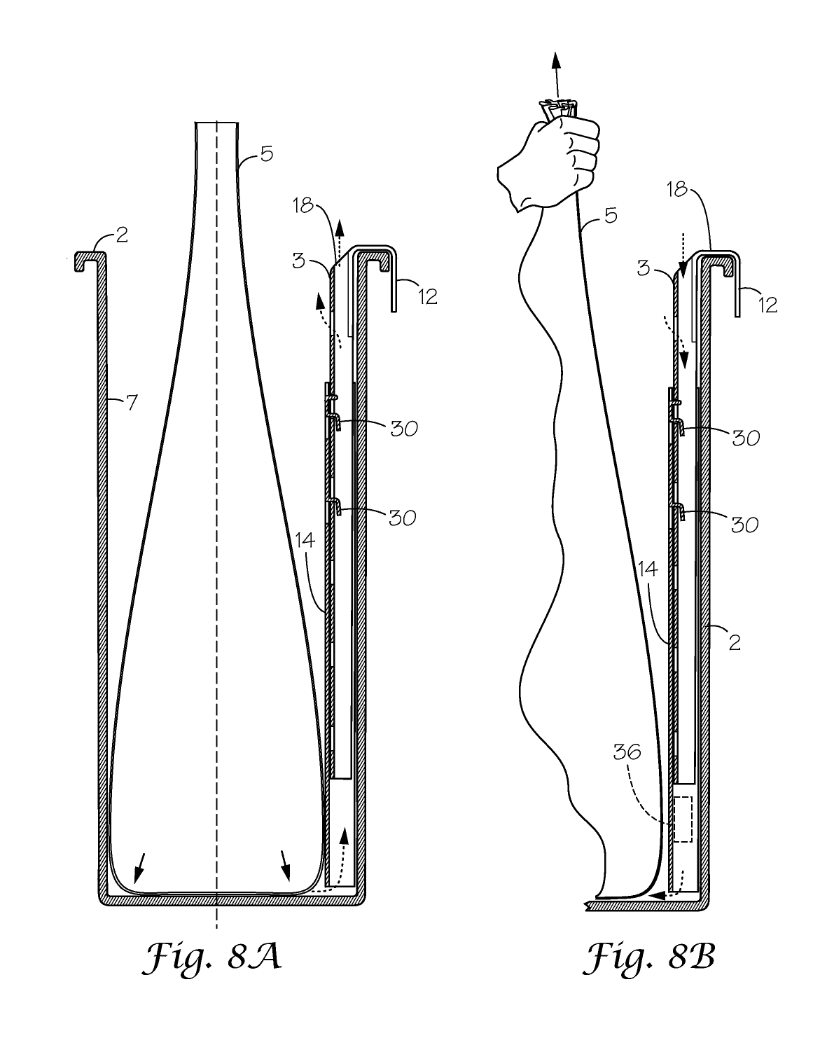

The hanging members 12, also referred to herein as clips, suspension members or suspension hangers, perform as fasteners or retainers for the vent device 3 at the top end thereof as shown in detail in FIGS. 7-8B. In the embodiment of FIG. 9C the hanging members 12 are formed from the plastic blank 80 as described above. This particular single unit construction is advantageous because of low cost and simplicity and, also, because of the flexibility of application of the single body plastic vent device 3 to a variety of trash containers. Other type of suspension hangers 12 may be used or attached to the main body of the vent device 3 at the top end. For instance, metal clips could be used and attached to the top edge of the main body by drilling holes and using screws. Other types of attachment for such metal clips will be apparent to those skilled as well. An advantage might be the elimination of the need to bend and mold the plastic clips from the plastic blank 80, which could help promote stacking and shipment. However, these types of separately attached clips may be disadvantageous because of requiring additional construction steps and parts and eliminating the convenience of the unitary body construction.

Regardless of the type of hangers used, the desired embodiment will provide suspension hangers 12 that are flexible in combination with the elongate body's flexibility for application to existing varieties of trash containers. In particular, such as shown in the embodiment of FIG. 4, the suspension hangers are attached by applying inward pressure to change the angle of the suspension hangers 12 to match top ridge of trash container 2. By this means, the suspension hangers 12 move laterally to accommodate the shape of trash container's lip, whether square, oval or round. The suspension hangers 12 also flex to accommodate the width of the container lip along with the overall shape of container. In this same manner, one may change the suspension hangers' design or size to accommodate different types of containers, for instance with large thick rims or other unusual features.

The pressure of the suspension hangers 12 due to elastically flexing to accommodate the edge rim of the trash container 2 may assist to retain the vent device 3 on the container. In particular, this retains the vent device 3 within the container while removing a trash bag, even as the bag liner slides upward against the vent device's elongate body. This bag removal process is aided by smooth tapered edges on the vent device elongate body that prevent snagging, and the pressure of suspension hangers 12 that secures the position of the vent device 3. The bag becomes easy to remove, as the eliminated vacuum relieves friction between the bag and the vent device 3 and, also, the container's inner sidewall 7. In certain containers, the suspension hangers 12 may tend to lack sufficient pressure or friction against the rim of the container to retain the vent device 3 therein during removal of a bag, in this case screws or other attachment device may be added to the suspension hangers 12 to accommodate the need to permanently attach the vent device 3 to the trash container 2.

The suspension hangers 12 hang over the rim edge of the trash container 2 as shown in FIGS. 3-4 and FIG. 7 so as not to interfere with the complete and full opening and closure of any lid, top or other closure device that may be present on the trash container 2. The top of each suspension hanger is design with a flat surface that will lie flush against the top of the rim of the container. Further, the typical lid will include an overlapping edge for holding a bag that will cover the suspension clip. Meanwhile, the bag liner also covers the suspension hanger as shown in FIG. 7. Thus, during use, the suspension hangers 12 and the vent device 3 are completely out of view from the consumer, as the remainder of vent device 3 beside the suspension hangers 12 is also covered by the bag and contained inside of trash container 2.

The vent device chamber is usually formed by edges of the side members 16 extending from the main body member abutting the inner sidewall 7 of trash container 2 and forming the elongate chamber for air flow. The actual shape of the vent's elongate body may be changed to meet specific ornamental or functional design preferences. Such feature of the elongate body may enhance the flexibility or appearance of the device. In particular, the vent's central main body member may be curved or ribbed. The combination of the main body member and elongate side members 16 of the vent device 3 forms an inner channel or vent chamber as discussed above and below.

The design may be further modified by adding a back side on the main body between each side member to enclose the vent's elongate body, forming a tubular body. In addition, the main body may be modified with contemplation of alternate means for attachment of the vent device 3 to a trash container 2, rather than requiring the use of the suspension hangers 12. For instance, a pair of elongate flange members may be incorporated through attachment to the side members to form a back face on the vent device 3. The back face will provide a convenient place for the attachment of an adhesive or glue. Such flange members on both sides of main body may include a double-sided pressure sensitive adhesive tape attached thereto. Thereby, the vent device 3 may use adhesive that is attached to underside of each flange for attachment. The adhesive strip may include a removable cover strip, or the adhesive may be packaged for addition to the flange members during installation. In each case, a consumer may carefully position the vent device 3 and press the adhesive of each flange member to the inner sidewall 7 of the container to attach the vent device 3. Using an adhesive means for attachment of the vent device 3 may remove the need for hanging the device with suspension hangers 12.

The alternative embodiment without suspension hangers 12 may promote stacking of the vent device bodies by removal of interference caused by the protrusion of the clips. Further, using adhesive rather than suspension hangers 12 may promote attachment of the vent device 3 to an even greater variety of containers because of removal of clips and need for the clips to fit and attach securely over the rim of a trash container 2. In some cases glue might even be preferred for attaching the vent device 3 to the inside wall of a trash container 2 where a permanent vent is desirable or clips would get in the way of operation of a container lid. Nonetheless, elimination of the hangers will have certain recognized disadvantages. For instance, the adhesive may not work well without first cleaning the inside of the trash container 2, which may discourage adoption of the vent device 3. Also, installation of the vent device 3 will be more difficult, as ensuring correct position during installation will be up to the consumer and errors could cause inappropriate operation because of decreased airflow. Still another disadvantage of using adhesive is that the vent device 3 will not be easily moved to a different trash container 2. In view of this, other alternatives to suspension hangers 12 and adhesive might also be considered such as using a hook and loop fastener strip along the flange member in place of hangers or adhesive. Hook and loop fasteners would at least preserve and allow for change and portability from one container to another, but would still require proper position and more complicated cleaning of surfaces and installation.

After the vent device 3 is attached to the inner sidewall 7 of the trash container 2, an inner channel is formed by the main body and shape of vent device 3. The inner channel is formed by the bends on each side of the main body member forming the inward side members 16 extending in the same direction toward the sidewall 7. The vent device 3 abutting the sidewall 7 of the container provides a relatively large inner channel for plenty of air throughput for release of vacuum. The air flows instantly when a bag liner is removed from the container because of size of the cavity formed by channel. The air flow mechanism works with the large angled top opening of vent device 3 to provide large amounts of air flow without restriction. Removal of a bag from the container opens the large mouth of the inner channel at top of the vent device 3 naturally when the bag liner is lifted. Lifting the bag exposes the top opening so that air can immediately flow into and through the top of the channel. The large angled opening of the top end works with large bottom opening of the vent device 3 to continue a large amount of air flow without restriction.

As in the embodiment shown in the figures, an exemplary device includes about a one inch clearance between the vent main body's bottom end and the bottom of the trash container 2. The actual length of the body of the vent device may be adjustable. In a two-piece vent device 3, the length may be varied by attaching a first elongate body section 24 to a second elongate body section 26 as shown in FIGS. 1-4. While other embodiments and variations will be apparent to those skilled in the art upon reviewing the present specifications, an exemplary embodiment shown incorporates clips formed from the plastic body sections of the device.

FIGS. 1-2 show the device from front and rear and illustrate how the pre-formed slots 28 and clips 30 connect the two body sections 24, 26 together to determine the length of the device. The separate body sections may be attached at a specific location using the selection of particular slots 28 along the length of the first body section 24. The slots 28 are formed in the first body section 24 by cutting a rectangular portion in the horizontal center of the first body section in several spaced positions. The slots 28 of the first body section 24 receive the pre-formed clips 30 on the second body section 26. Several slots 28 are provided along the length of the first body section 24 so that the overall length of the device 3 may be adjusted according to the slots that the clips 30 are inserted into. FIGS. 3-4 illustrate how the length of the device 3 is determined by the height of the trash container 2. For a shorter container than shown in these figures, the clips 30 could be relieved from the chosen slots 28 and moved to slots further upward on the first body section 24 toward the suspension clips, whereby the overall length of the vent device 3 would be shortened.

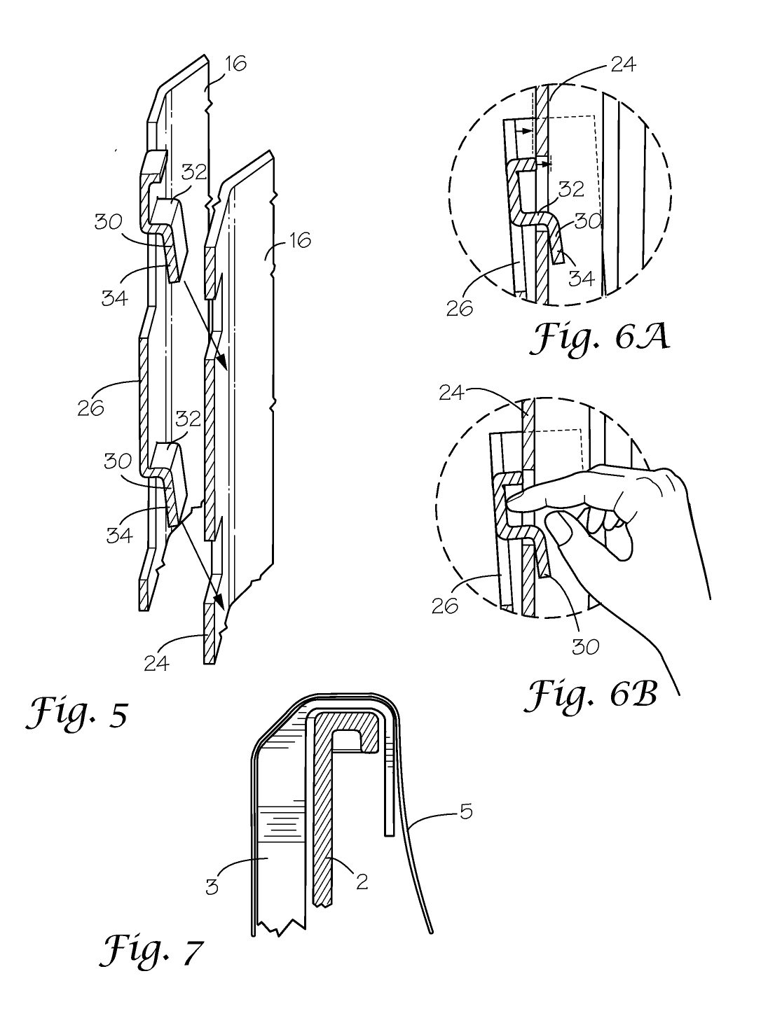

FIGS. 5-7 illustrate in more detail how the clips 30 are pre-formed at spaced positions within the second body section 26 and connected to slots 28 in the first body section 24. The clips 30 are formed by cutting three sides of a rectangular section of the second body section 26. The small section is cut in a location horizontally centered on the surface of the first body section 24 at two or more vertical locations. These cuts form rectangular tabs for further manufacture into the clips 30. The rectangular tabs are crimped and formed into clips 30 as shown in FIG. 5 by bending a section 32 perpendicular to the surface of the second body member 26, then forming a second bend perpendicular to the first to form a flange 34 projecting downward from the top of the body member and being spatially separated and parallel to the body member. The separation of the body member and flange 34 of each clip 30 allows the clip to be inserted into the slots 28 of the first body member 24 as shown in FIG. 6A.

The clips 30 and the slots 28 are equally spaced on the separate body sections for insertion of the clips into the slots. The clips 30 should be tight enough to create friction between the two body members 24, 26 when the clips are inserted into the slots 28, whereby the two body members are locked together to fix the length of the vent device 3. However, the device may be adjusted by forcibly pushing the clips 30 back out of the slots 28. During insertion of the clips into the slots, or removal, some force may need to be applied to the clip to assist in separating the clip from the wall of the body member so that the clip flange 34 may move through the slot 28. This pressure may be applied to the clip portion of the body member by hand as shown in FIG. 6B. The plastic forming the second body member 26 is flexible enough in the embodiment to bend away from the first body member 24 and create an angle between the two body members for insertion or removal of the clips 30.

Once the upper and lower body members are clipped together they are inserted into a trash container 2 and a bag liner 5 may be inserted as shown in FIG. 8A. Typically, a bag liner forms a seal along the inside of a trash container 2 once the weight of trash pushes the bag downward as illustrated by the downward arrows in FIG. 8A. With the vent device 3 inserted, air is easily released upward through the vent device during insertion of a bag liner 5 to eliminate any air pockets beneath the bag. Moreover, the bag liner 5 does not form a vacuum beneath the bag when the surface of the bag is pressed against the bottom of the trash container 2 and the interior sidewall 7 of the trash container. Instead, the vent device 3 allows air to flow into the trash container 2 through the vent device when the trash bag liner 5 is pulled upward out of the container as shown in FIG. 8B.

Another advantage of the vent device 3 or 90 provided herein is the easy provision for a fragrance through addition of a scented component 36 in combination with a holder or attachment means for incorporating into the main body of the vent device. A scented component 36 may be situated within the vent device so that, as air flows through the inner channel of the vent device during bag changes, the scented component will distribute a fragrance into the interior of the trash container 2. The trash container is deodorized and refreshed anytime that a trash bag liner 5 is removed. The main body of the vent device conveniently protects the scented component 36 from damage, as the scented component is sequestered from the pressure of the trash bag. Also, the vent body keeps the scented component from interfering with the bag liner and causing hanging or other obstacle to bag removal. Such scented component may hang on the top end of the vent device main body from the top edge 18 or lip of thereof. Once the scented component has been depleted, the vent device may be easily removed from the trash container for replacement of the scent component.

In a single piece vent device 90, the length may be varied by manufacture to certain lengths or by inclusion of some means for adjusting the length after manufacture, such as score lines 88 or other means for adjusting length by removal of portion from bottom of vent body. A version of the device manufactured with score lines across the elongate body near the bottom end for adjustment of the length is shown in FIGS. 9A-9C. The bottom end of the vent device 3 forms an opening of about two square inches in the bottom of the passage, combined with approximately the same size opening at the top end of the passage forming the combined intake capacity.

Several advantages are noteworthy in the present device. First, the vent device 3 is completely hidden from view when a new trash bag is inserted into the trash container 2. The vent device 3 does not become visible except when changing bags. Further, even the top mouth of the vent device is covered by the bag liner 5, thus there are no holes formed through the trash container 2 by the inclusion of the vent device 3 or 90. This prevents the vent device being a mechanism by which insects or rodents might invade a trash container.

These and other objects of the invention will be apparent to those skilled in the art and the invention should be interpreted broadly in accordance with the claims that follow.

1. A vent device for trash containers comprising:
a. an elongate body including a top end and a bottom end;
b. a main body forming a center length of the elongate body;
c. elongate side members bordering each side of the entire length of the main body and the side members being angularly extended inward at an angle from opposing edges of the main body;
d. an elongate channel defined by the side members;
e. a passage defined by the combination of the elongate channel and an interior surface of a trash container for transfer of air between the elongate body of the vent device and the interior surface of the trash container when the vent device is inserted into the trash container; and
f. a suspension hanger attached to the top end of the elongate body, whereby the device is retained by the rim of the trash container when inserted.

2. A vent device for trash containers as in claim 1 in which said elongate body is formed of plastic and said suspension hanger comprises of an extension of said elongate body from the top end, and the suspension hanger includes a tab extending from each side member, each tab is bent whereby a portion is situated approximately perpendicular to each side member and approximately parallel to the main body, the remaining portion of each tab is bent twice, whereby the tab forms a U-shaped suspension hanger.

3. A vent device for trash containers as in claim 1 in which said side members angularly extend obtusely from the opposing edges of the main body.

4. A vent device for trash containers as in claim 1 in which said elongate body consists of a first body section and a second body section that are detachable from each other to adjust the length of the elongate body.

5. A vent device for trash containers as in claim 4 in which said first body section includes at least three slots and said second body section includes at least two clips, said clips slide into said slots for attaching the first and second body sections, selecting the length of the vent device and forming the elongate body.

6. A vent device for trash containers as in claim 5 in which said slots are each formed by cutting rectangular portion in the first body section in a spaced position with respect to the other slots and said clips are each formed by cutting a rectangular tab in the second body section in a spaced position with respect to the other clips, said slots and said clips being situated in equally spaced positions for insertion of the clips into the slots.

7. A vent device for trash containers as in claim 1 including at least one scored line across the elongate body near the bottom end whereby a portion of the elongate body can be broken off from the bottom end to shorten the length of the vent device.
